(19) United States
(12) Patent Application Publication
(10) Pub. No.: US 2006/0200561 A1
(43) Pub. Date: Sep. 7, 2006

(54) Multicast proxy apparatus

(75) Inventors: Katsuyoshi Tsuhara, Kawasaki (JP); Akihiro Horiuchi, Chikushino (JP)

Correspondence Address: BINGHAM MCCUTCHEN LLP, 3000 K STREET, NW, BOX IP, WASHINGTON, DC, 20007, US

(73) Assignee: FUJITSU LIMITED

(21) Appl. No.: 11/360,565

(22) Filed: Feb. 24, 2006

(30) Foreign Application Priority Data
Mar. 7, 2005 (JP) 2005-062936

(51) Int. Cl. G06F 15/173

(52) U.S. Cl. 709/226

(57) ABSTRACT

A technique to acquire well-balanced multicast communication quality of each terminal on the basis of the multicast communication request from a plurality of terminals is provided. A multicast proxy apparatus comprises a server manager for management of communication bandwidths corresponding to each content and addresses of servers for providing contents of the communication bandwidths, a terminal manager for management of weight or priority order of each terminal, and a server selector for receiving content transmission requests from each terminal, acquiring the information of at least one bandwidth regarding distribution of the content, and selecting a content server on the basis of the remaining available bandwidths and weight or priority order of the terminals.

### BACKGROUND OF THE INVENTION

1. Field of the Invention

The present invention relates to multicast communication in an IP network and particularly to a proxy apparatus for accommodating multicast terminals to be installed in a household.

2. Description of the Related Art

In recent years, broadband ADSL and optical fiber communications are rapidly spreading with popularization of the Internet. Moreover, large capacity bandwidth is also used for communications of users and it is now possible to watch the image and hear the music of the contents on the real time basis with the unicast communication.

The unicast communication, however, includes a problem for the contents providers, for example, that the communication bandwidths multiplied with the number of users are consumed even when the identical contents are transmitted. Meanwhile, the multicast communication includes a merit for the contents provider that bandwidth consumption can be suppressed, namely the bandwidths used do not increase proportionally even when the number of users increases in the case where the identical contents are transmitted. In view of enjoying the merit explained above, the operation is now starting, in which the contents are distributed, from the server, with the multicast communication via the Internet to the terminals (hereinafter, referred as “PC” in some cases) supporting the multicast protocol.

It is possible, from the technical viewpoint, that the contents transmitted from the server with an IP network are subjected to bandwidth control up to an edge router provided nearby the users. For example, it is possible to guarantee the bandwidth up to the edge router from the server with employment of MPLS or RSVP protocol or the like. Moreover, the lowest bandwidth can also be ensured for each identifier of VLAN up to the routers provided within the households from the edge router.

A household router can accommodate a plurality of terminals. Accordingly, this household router is identical in structure with a small network (households, small groups, SOHO, and collective housings are sometimes called as “households” in this specification) and therefore bandwidth control and priority control for the multicast packets between such small network and edge router are required. Since the multicast packets are duplicated with the edge router and are then transferred, the area between the edge router and the household router easily becomes a bottleneck of the bandwidth. As the router used in the households, a product which can support the bandwidth of 100 Mbps or higher is available in the market at a lower price. Accordingly, shortage of bandwidth of the network in the households can be eliminated with use of the same router.

Namely, when the bandwidth control is not executed in such a small network, a plurality of users cannot likely watch and hear the contents without any problem if a total of the bandwidths used by a plurality of users has exceeded the available bandwidths. As the contents by the multicast, moving images of the television broadcast may be assumed. However, the moving image and music has been subjected to data compression as represented by the MPEG and therefore missing of packets will give influence on the data in unit of the compressed data or the entire part of one frame, resulting in disturbance of image and deterioration of sound quality.

Accordingly, management of communication bandwidth is a very important problem in the image data and in communication of image data.

As described in Japanese Patent Application JP-A No. 2002-290452, relating to bandwidth control in the multicast communication explained above, a technology has been disclosed to provide a communication service bandwidth control method and a system utilizing the same technology, in which the bandwidths are assigned with priority when the contents distributed to a plurality of subscribers are matched with the tastes and objects of the subscribers in the link or network having the limited communication bandwidths.

### SUMMARY OF THE INVENTION

As explained above, the bandwidths used for multicast communication in the small network are not under the management at present. Therefore, almost all terminals which enter the congesting state because of the reasons explained above display, for example, disturbed images/video of contents because of cancellation of multicast packets.

Therefore, an object of the present invention is to provide a technology for acquiring the balanced quality of multicast communication of each terminal on the basis of the request for the multicast communication from a plurality of terminals.

The multicast proxy apparatus of the present invention can transmit a received multicast packet to a plurality of terminals which have requested contents, comprising: a server manager for managing communication bandwidths corresponding to at least one address required for receiving a plurality of contents from at least one server, a terminal manager for managing weight or priority order of each terminal, and a server selector for receiving a content request from one of said terminals, acquiring, from the server manager, at least one bandwidth and at least one address regarding reception of a content, and selecting a server on the basis of one of the weight or priority order of said one of said terminals and a remaining available bandwidths.

The multicast proxy apparatus is capable of selecting the server which provides the contents having the adequate bandwidths in accordance with the weight or priority order of each terminal and is distributing the contents to the terminals using the well-balanced bandwidths.

### BRIEF DESCRIPTION OF THE DRAWINGS

FIG. 1 is a diagram illustrating an example of structure of a network including the multicast proxy apparatus of the present invention.

FIG. 2 is a diagram illustrating an example of the basic structure of the multicast proxy apparatus of the present invention.

FIG. 3 is a diagram illustrating operations of each section of the multicast proxy apparatus of the present invention.

FIG. 4 is a diagram illustrating a format of a database of a manager for management of server of the present invention.

FIG. 5 is a diagram illustrating the format of the database of the manager for storing the terminal setting information of the present invention.

FIG. 6 is a diagram illustrating the format of the database of the manager for storing terminal states of the present invention.

FIG. 7 is a diagram illustrating the format of the database of the manager for storing bandwidths of the multicast proxy apparatus.

FIG. 8 is a diagram illustrating the format of the database of the manager for storing the premium information in accordance with pay-program and taste of program.

FIG. 9 is a diagram illustrating process flows of the multicast proxy apparatus of the present invention.

FIG. 10 is a diagram illustrating operation sequence of the multicast proxy apparatus of the present invention.

FIG. 11 is a diagram illustrating the priority control sequence among the terminals of the multicast proxy apparatus of the present invention.

FIG. 12 is a diagram illustrating the priority control sequence in accordance with the number of terminals.

### DETAILED DESCRIPTION OF THE INVENTION

An embodiment of the present invention will be explained with reference to the accompanying drawings.

1. Multicast Proxy Apparatus and Network System

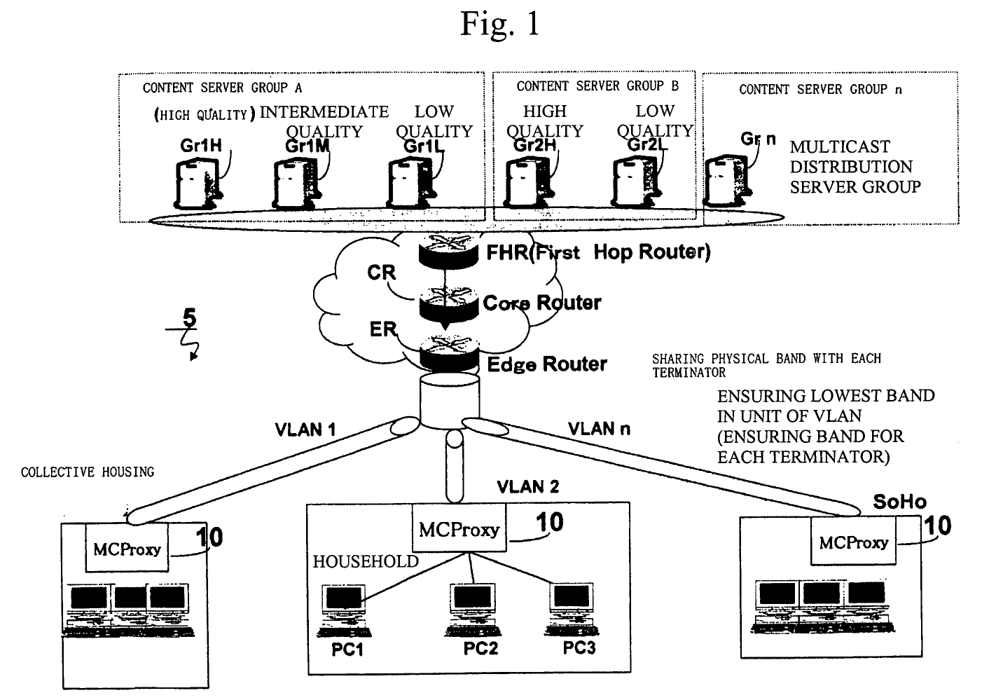

FIG. 1 is the diagram illustrating a structure of an example of a network system utilizing the multicast proxy apparatus (MCProxy) 10 of the present invention.

In this network system, a certain content can be provided to users (viewers) in different bandwidths (for example, high definition image quality in the broadband) with three content servers such as high quality (Gr1H), intermediate quality (Gr1M), and low quality (Gr1L) for the identical contents. As a content of high quality images (broadband), for example, it should be noted that image size is large, number of frames transmitted per unit time is large, and compression rate of display image is small.

As the profiles of these three content servers, different IP addresses may be assigned for each content server by operating a plurality of content servers on an independent computer.

Moreover, three content servers may also be operated on a computer.

The stream of IP multicast packets transmitted from these content server groups is distributed to households via the FHR (First Hop P Router), core router, and edge router of FIG. 1. Moreover, the edge router (access router is also allowable) is capable of insuring the lowest assuring bandwidth with the contract or the like via VLAN (Virtual LAN) for distribution to households. Namely, in the present invention, it is assumed that the lowest bandwidth is guaranteed with a certain means in the communication up to the multicast proxy apparatus (MCProxy) 10 in the household from the content server. Moreover, it is also possible to guarantee the bandwidths using the bandwidth assuring technology such as MPLS and RSVP for the path up to the edge router (or access router) from the content server when the content request is issued.

A plurality of terminals (for example, PC1, PC2, PC3) can be connected to the multicast proxy apparatus 10.

2. Function of Each Section in Multicast Proxy Apparatus

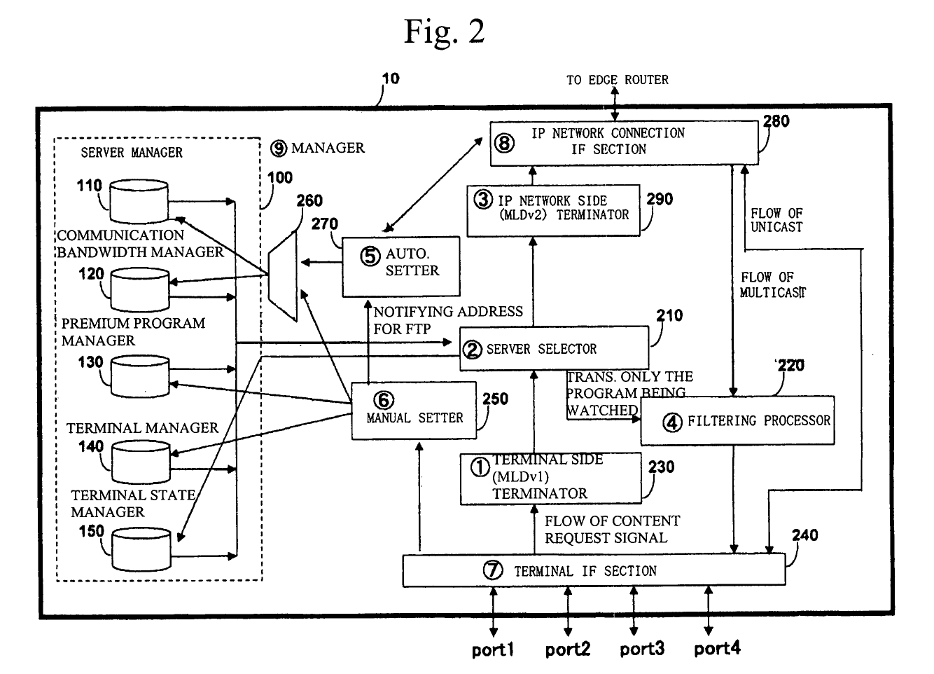

FIG. 2 is a diagram illustrating an example of basic structure of the multicast proxy apparatus 10 of the present invention.

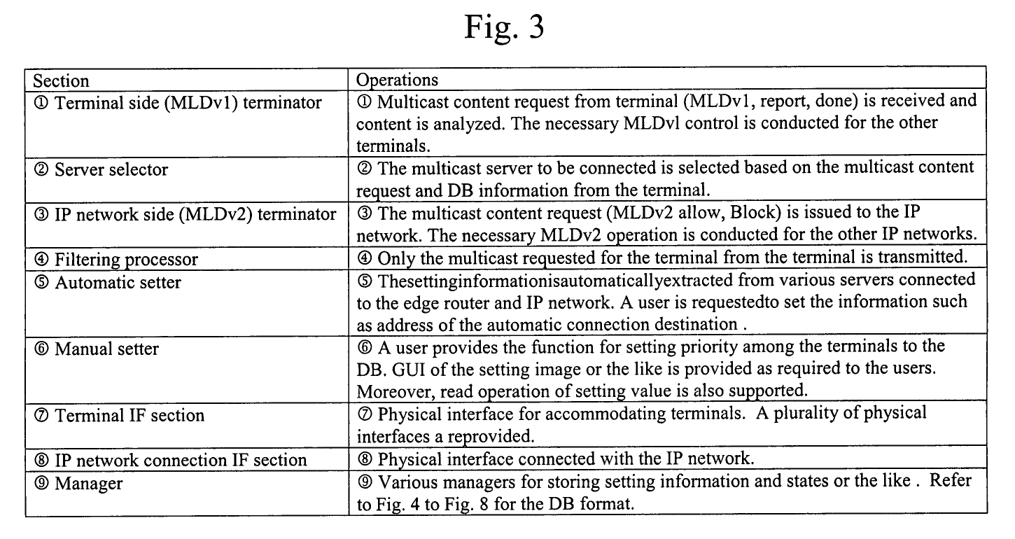

FIG. 3 is a diagram illustrating a summary of operation of each section of the multicast proxy apparatus of the present invention of FIG. 2. □ to □of FIG. 3 correspond to □ to □ of FIG. 2.

2.1 Setting Function

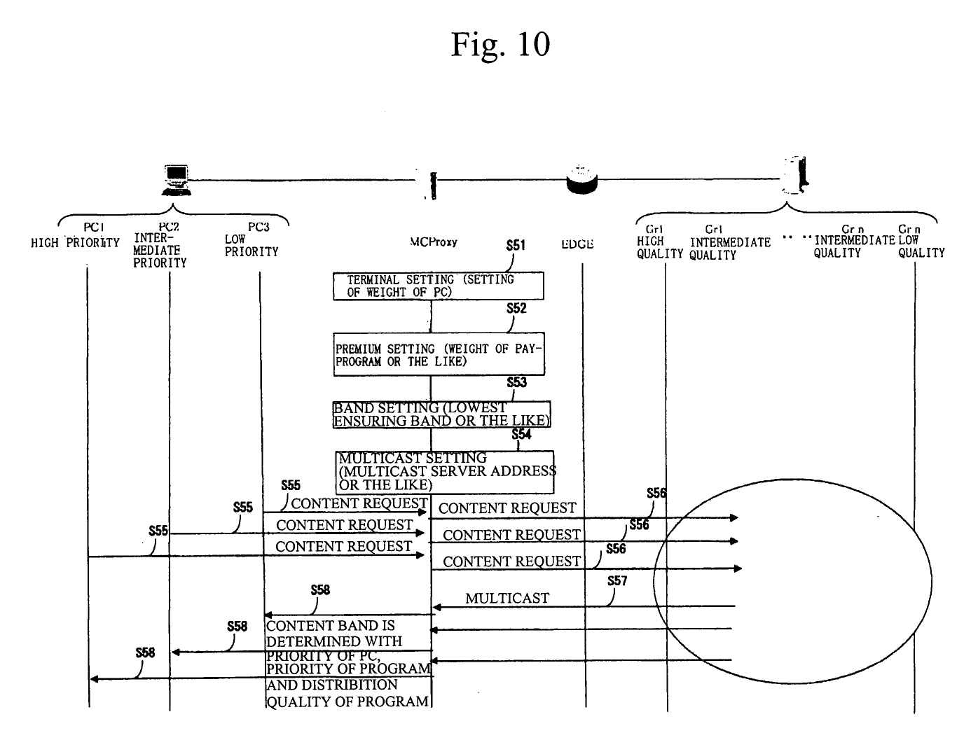

First, an administrator or a terminal user of the multicast proxy apparatus 10 is requested to set the entire part or a part of the network, terminal, and content before introducing and starting operation of this apparatus. Explanation will be made with reference to FIG. 2 and FIG. 10.

In FIG. 2, a terminal (for example, PC1) connected to any of a plurality of connecting ports (port 1 to port 4, however, not limited to these ports) for the terminal designates the particular IP address (for example, (192.168.0.1) or unique local unicast address of IPv6) in place of the URL and also connects such IP address to the manual setter 250 via a terminal IF section 240.

The manual setter 250 generates one or more menus based on the HTML language for inputting, from the Web browser, the information to be set to each manager (for example, terminal manager 140, premium program manager 130, server manager 110, and communication bandwidth manager 120) and displays these menus in the Web browser windows of the PC1. Moreover, the environment after introduction of the multicast proxy apparatus 10 can be set manually by storing the information inputted from the Web browser windows to each corresponding manager.

A selector 260 is also provided for exclusive control of the server manager 110 and communication bandwidth manager 120 to which data is written from both an automatic setter 270 and the manual setter 250.

An administrator of the multicast proxy apparatus 10 inputs and sets the management information required for each manager which will be explained below.

2.1.1 Terminal Manager

In the steps S51 to S54 (FIG. 10), setting is made for the multicast proxy apparatus and terminals.

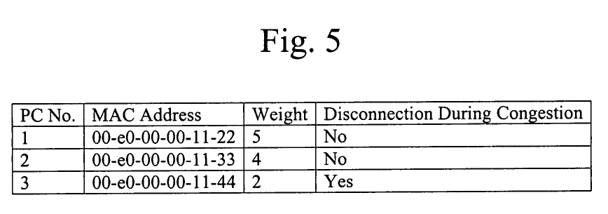

The manual setter 250 displays, on the Web browser display window of PC (for example, PC1), a menu for inputting “PC. No.”, “MAC address”, “weight”, and “disconnection during congestion” as the data corresponding to the setting information described in regard to FIG. 5. An administrator inputs and sets, for each terminal, the values of “weight (for packet transfer)”, and “disconnection during congestion” corresponding to terminal users (for example, PC1 to PC3)

A value of weight can be assigned to each PC. Namely, a value of weight of each PC is assigned to the bandwidth to the total value of all weights in accordance with the weight of each PC for the total bandwidths.

For example, when the contacted lowest ensured bandwidth is 8 Mbps, weight of PC1 is 5, and total weight value of all PCs is 10, the bandwidth which can be assigned to the PC1 becomes 4.0 Mpbs (=8*4/10). A value of weight may be identical to or different from the value of each terminal.

The multicast proxy apparatus 10 selects and administrates the bandwidth (bandwidth of contents requested by the PC1) of PC1 so that the content request (for example, corresponding to report of the MLD: Multicast Listener Discovery Protocol) from the PC1 satisfies 4 Mpbs. Details will be described later.

Setting of the “disconnection during congestion” is requested when the total of content bandwidth request from a plurality of terminals has exceeded the congestion disconnection bandwidth. The PC, which is set to “Yes” in the “disconnection during congestion” and to a small value of “weight”, is disconnected first. If the content request bandwidth is still insufficient, the PC, which is enabled for “disconnection during congestion” and is set to a next small value of “weight”, is disconnected next. This process is repeated until the bandwidth request is satisfied, otherwise, until there are no terminals as the disconnection object.

2.1.2 Terminal State Manager

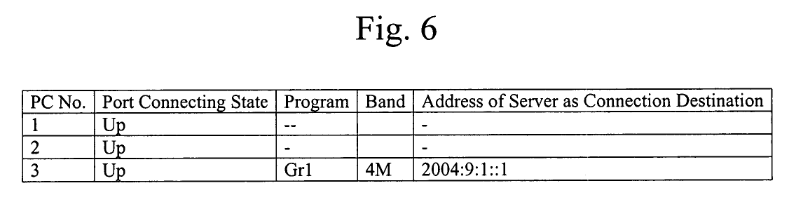

The server selector 210 records “PC No.”, “Port connecting state”, “program”, “address of server as connection destination” or the like to the terminal state manager 150 for the PC which is now making the multicast communication with the content server corresponding to the management information of the terminals state manager of FIG. 6. The server selector 210 controls the new content request from the terminals on the basis of the present state of each terminal recorded to the terminal state manager 150.

Moreover, the server selector 210 is capable of updating the state of each terminal to the terminal state manager 150 on the basis of the request to the edge router such as allow and block.

2.1.3 Server Manager

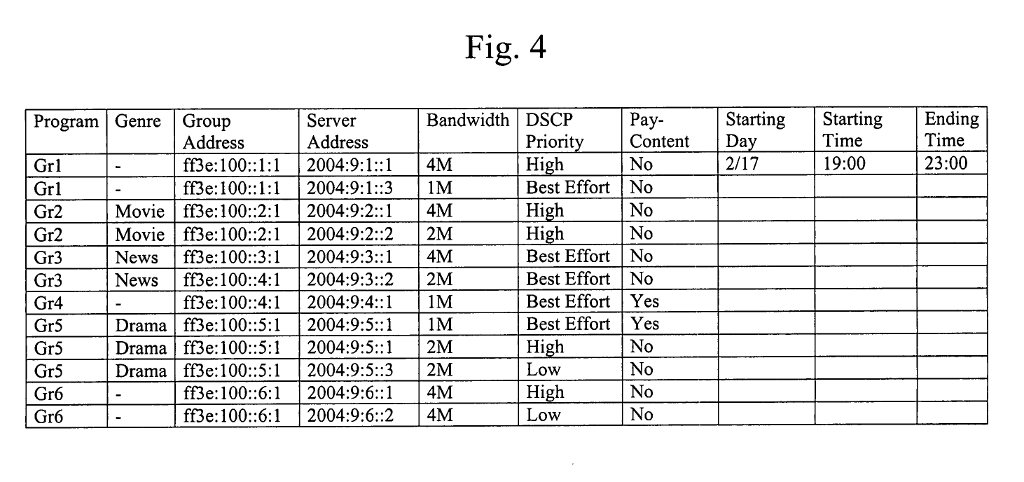

The manual setter 250 and automatic setter 270 display the menu for inputting “genre”, “Gr address (program address)”, “server address”, “bandwidth”, “DSCP (Differentiated Services Code Point) priority”, and “pay program” as the information corresponding to the programs of FIG. 4 on the Web browser windows of the PC (for example, PC1).

With a program used as the key, the information of at least a server address corresponding to this program, genre, group address (Gr address), server address, bandwidth, DSCP priority, pay-program/free-program, time and date of start and end is set to this server manager.

2.1.4 Premium Program Manager

In the step S52, setting is made for content request of the premium contents.

A value to be weighted as the priority is stored for the communication quality when the content request is issued for pay-content or content of particular genre. For example, ×2 indicates that the weight value is doubled.

2.1.5 Communication Bandwidth Manager

In the step S53, setting is made for bandwidth (lowest ensured bandwidth and bandwidth for starting disconnection during congestion).

The communication bandwidth manager 120 stores the bandwidth information of the link with which the multicast proxy apparatus 10 is connected to the external network and values for disconnection or the like during congestion.

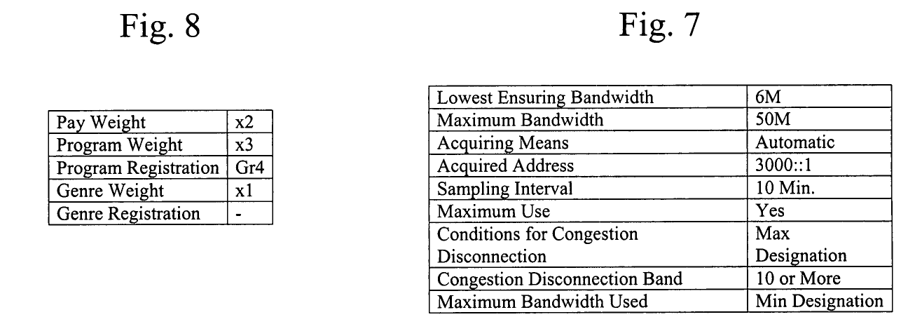

The manual setter 250 and automatic setter 270 displays a menu for inputting the “lowest ensuring bandwidth”, and “congestion disconnection bandwidth” or the like of the link connected to the external network to the Web browser windows of the PC (for example, PC1) in order to set the value of management information of FIG. 7. An administrator sets the value on the basis of the menu windows.

3. Automatic Setting and Automatic Update of Multi-Cast Proxy Apparatus

In the step S54, setting is made for server address and communication bandwidth for providing programs and multicast contents.

The necessary control information pieces must be set first before starting communication with the content server using the multicast proxy apparatus 10.

Namely, it is desirable for bandwidth control of a plurality of terminals being accommodated that the lowest ensuring communication bandwidth and highest communication bandwidth are automatically acquired and these are set to the communication bandwidth manager 120. Moreover, these may also be obtained manually but possibility for less accurate setting than the automatic setting is rather high.

Whether these data should be obtained automatically or manually can be automatically downloaded when the automatic acquisition and addresses of servers are set respectively to the communication bandwidth manager 120.

The automatic setter 270 automatically obtains (down-load) the program (content) information made public with the particular server with the FTP (File Transfer Protocol) and telnet or the like for the contents to be distributed and can set such program information, for example, to the server manager 110 and communication bandwidth manager 120. Moreover, the setting information may also be periodically down loaded and updated with the automatic setter 270.

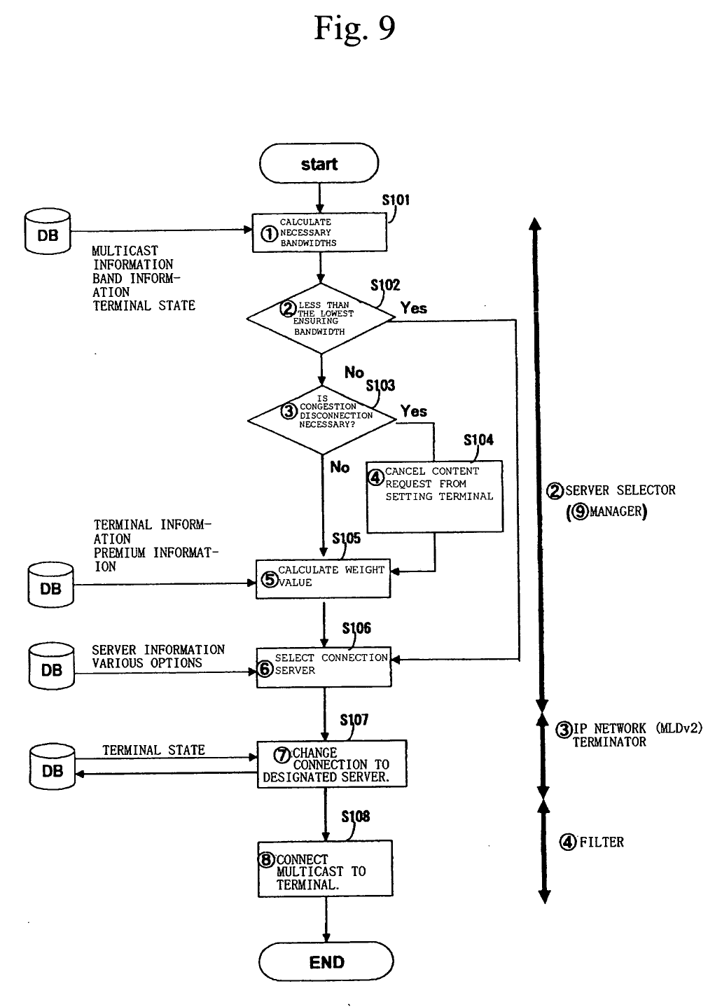

FIG. 9 is a diagram illustrating the process flow in which attention is paid to the cooperation with various managers in the operation example when the multicast content request is issued from the PC.

An example of operation when a certain user has received a multicast content request from a terminal (for example, PC1) connected to the port 1 of the multicast proxy apparatus 10.

For example, when the multicast proxy apparatus 10 receives the multicast content request packets from the PC1 with the terminal IF section 240 and recognizes these packets as the multicast protocol packets, this apparatus transmits these packets to the packet terminal side (MLDv1) terminator 230. Moreover, when the packets are unicast packets, the apparatus transfers the packets to an IP network connecting IF section 280.

The terminal side (MLDv1) terminator 230 terminates the multicast protocol packets, extracts the multicast group address and PC address of the multicast content request destination, and then transmits these data to a server selector 210. The server selector transmits these data to a filtering processor 220.

In the step S101, the server selector 210 (FIG. 2) makes access to the server manager 110 and obtains the bandwidth required for communication with the multicast group address using as a key for the bandwidth of the multicast group to which a certain terminal has issued a new content request.

In FIG. 4, for example, it can be understood that as the bandwidth when the Gr address (multicast group address) is ff3e:100::2:1, any of the bandwidths of 4 Mbps (content server address is 2004:9:2::1) and 2 Mbps (content server address is 2004:9:2::2) can be selected.

Here, present amount of bandwidth being used can be read from the terminal state manager 150 and the lowest ensuring bandwidth is also read from the communication bandwidth manager 120 in view of obtaining the bandwidth unused (present available bandwidth).

In the step S102, the maximum amount of bandwidth of the multicast group to which the content request is issued is compared with the bandwidth unused and it is judged whether the unused bandwidth is greater than the maximum amount of bandwidth (the total bandwidth used is less than the lowest ensuring bandwidth) or not.

When this condition is satisfied (the bandwidth used is larger), such content request is accepted indirect and the process branches to the step S106.

In the step S103, since the bandwidth is insufficient to satisfy a new content request, the congestion disconnection start bandwidth is compared with the total bandwidth used with reference to the communication bandwidth manager 120. When the total bandwidth used does not exceed the congestion disconnection bandwidth, the process branches to the step S105.

In the step S104, a terminal which can be disconnected from communication is extracted based on the terminal manager 140 for the terminals connected and the server selector 210 tries to acquire the necessary bandwidth by disconnecting the session under the communication. Namely, the terminal, which is under the communication and can be disconnected during congestion, is extracted by making access to the communication state manager 150 and terminal manager 140 to know whether there is a terminal which can be disconnected during congestion or not. When there is no terminal as a candidate which can be disconnected from the communication session, the process branches to the step S105.

In the step S105, the weight information of each terminal being connected is obtained from the terminal manager 140 and the bandwidth used of each terminal being used is also obtained from the terminal state manager 150. The total bandwidth ×weight value of each terminal having issued a content request/total value of weight is obtained as the bandwidth of each terminal. An exceptional case in which a plurality of terminals receive the exactly identical multicast will be explained later.

In the step S106, the group address (Gr address) and server address or the like are selected to satisfy the bandwidths assigned to each terminal by making reference to the server manager 110.

In the step S107, connection of server or destination of connection is changed on the basis of the selected Gr address and server address or the like by making reference to the terminal state manager 150.

In the step S108, the filtering processor 220 executes the filtering process to transfer the multicast packets transmitted from the content server to only the terminal which has issued the content request.

Summary of processes of the multicast proxy apparatus has been explained above mainly focusing on the cooperation with each manager.

FIG. 10 is a diagram illustrating an operation sequence of the multicast proxy apparatus.

In the step S51, a value of weight of each terminal explained above is set. In the step S52, the premium information common to each terminal explained above is set. In the step S53, the lowest ensuring bandwidth and congestion disconnection start bandwidth are set respectively. In the step S54, the information (server address, bandwidth, group address or the like) about the multicast contents is set.

Upon completion of setting of each manager, each terminal issues a content request to the content server and receives contents through the multicast communication.

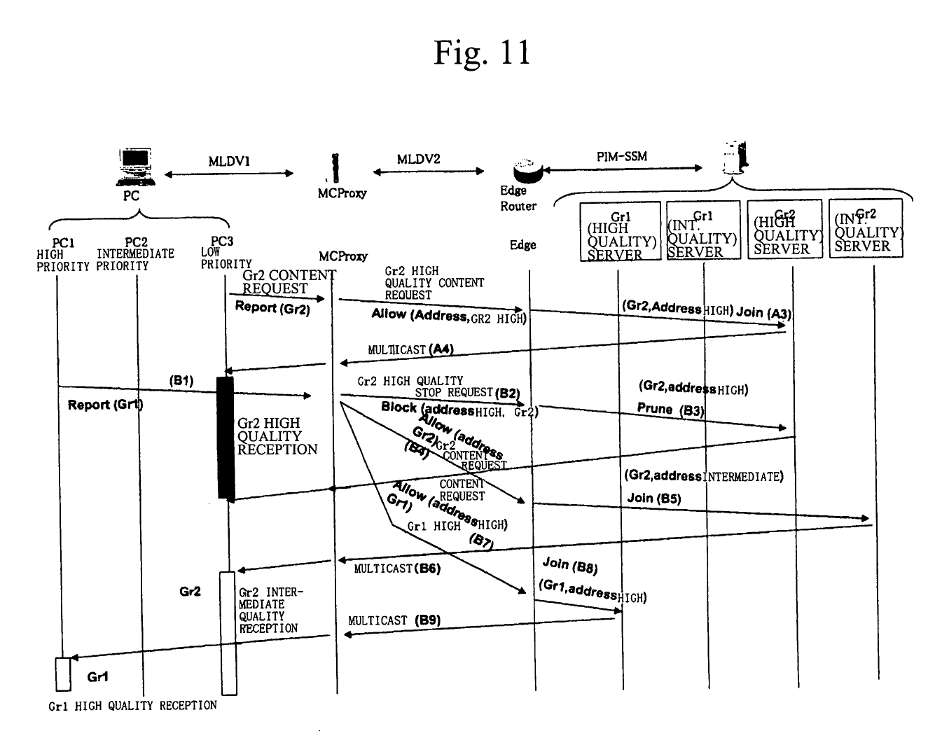

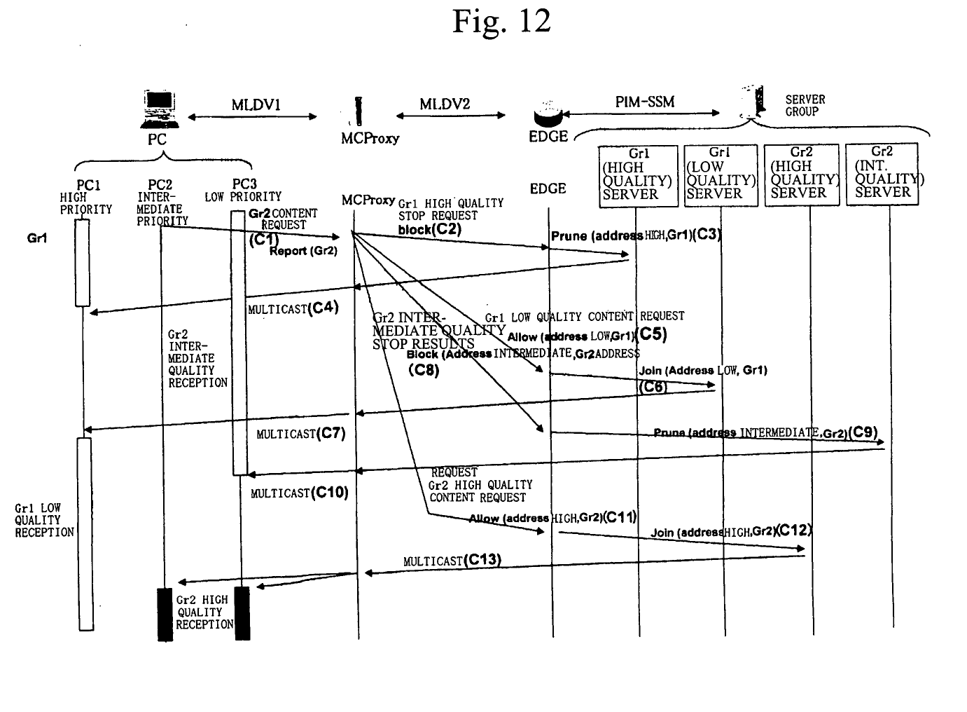

FIG. 11 is a sequence diagram illustrating the sequence of priority control by the multicast proxy apparatus of the present invention.

First, a connecting structure of a network apparatus of FIG. 11 will be explained.

A first hop router (FHR), although not illustrated in the figures, is provided as the router connected to the server side between each server and the edge router in order to support the multicast protocol and the multicast communication is conducted between the FHR and the edge router with the PIM-SSM (Protocol Independent Multicast-Source Specific Multicast). In this embodiment, a server group is described as gathering of a plurality of servers.

Namely, even if only one content exists, it is possible to provide the content matched with the network environment of users (lowest ensuring bandwidth or the like) by respectively preparing for the servers for high quality (broadband) content or low quality (narrowband) content. The server group can provide the contents of one or more different bandwidths in accordance with the quality of one content.

The multicast communication is executed with the MLDV2 multicast protocol between the multicast proxy apparatus and the edge router. Namely, the multicast proxy apparatus can designate a group address (program) and also an address of content server.

Namely, the server of the quality in different contents can be selected by designating the identical program and varying the address of server.

Communication between a PC and the multicast proxy apparatus can be realized by adequately selecting the content server having the priority control and particular bandwidth for each PC at the time of receiving the content request from each PC on the basis of the information of the lowest ensuring bandwidth, total bandwidth of multicast used by the PCs connected to the server, and weight.

Operations of the present invention will be explained in accordance with the sequence of the figure. (A1) to (C13) and titles thereof correspond those in the figure respectively.

(A1) Content Request to Gr2 Server from PC3

PC3 (low priority: weight value is 2) transmits the content request (Report (Gr2)) for the program of Gr2 to the multicast proxy apparatus (MCProxy).

In this case, the content request (Allow (Gr2 high quality server address, Gr2)) may be of the MLDV2 format. However, address designation of this server is ignored with the multicast proxy apparatus. Namely, this address designation is treated identically as the MLDV1 format.

The reason is that the multicast communication bandwidth supervises the multicast communication bandwidth and can provide the well-balanced multicast communication by selecting the content server to assign the optimum bandwidth to each PC on the basis of the relationship between the total multicast communication bandwidth used by each terminal and the lowest assuring bandwidth or the like.

For example, even if the content request is 4 Mbps, when the available remaining bandwidth is less than 4 Mbps, the multicast proxy apparatus sometimes updates the designated server address to the address of the content server using the adequate communication bandwidth (for example, 2 Mbps).

In more detail, for example, the multicast proxy apparatus receives the content request (MLDv1 report (Gr2) in this embodiment) of the program of Gr2 from the PC3 with the terminal side terminator 230 and then transmits the message of this content request to the server selector 210.

The server selector 2 refers to the server manager 110 and obtains the information that the maximum bandwidth of the program of Gr2 is 4 Mbps (the minimum bandwidth is 2 Mbps).

Next, it can be understood that the lowest ensuring bandwidth is obtained from the communication bandwidth manager 120 and this bandwidth is 6 Mbps. Namely, the server which can provide the content of 4 Mbps can be selected (the process branches to the step S106 in the step 102 of FIG. 9).

(A2) Content Request to Gr2 High Quality Server

The server selector 210 obtains the server address 2004:9:2::1 of the 4 Mbps content of the Gr2 program (high quality) from the server manager 110 and transmits the MLDv2 allow (2004:9:2:1, ff3e:100::2:1) to the edge router (having the multicast router function) as the content request for the content server (2004:9:2::1) via an IP network side (MLDv2) terminator 290. In this case, since “high” is designated as the DSCP priority, the process is carried out to conduct high packet transfer. Moreover, since the content is not the “pay”-content, ordinary process is carried out. But, the content is matched with the “pay”-content, genre and registered program, the server may be selected using the weight of the designated magnification factor (integer or integer having fixed point).

(A3) Process of Multicast Edge Router

The edge router having received the content request from the multicast proxy apparatus extends, for the multicast communication, the connection to the First Hop Router (FHR) accommodating the Gr2 content server (2004:9:2::1) designated with use of Join of the PIM-SSM protocol. When the multicast communication with the content server (2004:9:2::1) is already conducted with the other terminals, a new connection is not extended for the multicast communication by the PIM-SSM protocol.

(A4) First Hop Router (FHR)

The FHR receives the data for multicast communication at least from the Gr2 content server. Upon reception of Join to the designated Gr2 content server (2004:9:2::1) using the PIM-SSM protocol, the FHR starts transmission of the multicast packets from the Gr2 content server (2004:9:2::1) to the edge router.

Here, the multicast proxy apparatus can receive the content from the Gr2 content server (2004:9:2::1). The received multicast packets are transferred, with the filtering processor 220, to the PC3 which has issued the content request. The PC3 is capable of receiving the content transmitted from the Gr2 content server (2004:9:2::1).

(B1) Reception of Content Request to Gr2 Server from PC1

The multicast proxy apparatus (MCProxy) receives a content request (Report (Gr1)) for the program of Gr1 from the PC1 (high priority: weight value is 5) during distribution of received content to the PC3. In this case, the content request (Allow (Gr1 high quality server address, Gr1) may be of MLDV2 format as explained above.

The server selector 210 refers to the server manager 110 to obtain the information that the maximum bandwidth of the program of Gr1 is 4 Mbps (the other lowest bandwidth is 1 Mbps). Next, the server selector 210 also obtains the lowest ensuring bandwidth of the external link from the communication bandwidth manager 120 and detects this lowest ensuring bandwidth is 6 Mbps. Here, it is also detected that the PC3 already uses the bandwidth of 4 Mbps and the remaining maximum bandwidth is 2 Mbps. Therefore, the processes up to the step S105 from the step S102 in FIG. 9 are conducted. Since the congestion disconnection bandwidth (FIG. 7) is 10 Mbps or higher, disconnection process of session during communication is not conducted and the weight value calculation and bandwidth assignment process are conducted.

The weight value can be detected by referring to the terminal manager 140. Namely, the PC1 has the weight value of 5, while the PC3 has the weight value of 2. The weight values of PC1 and PC3 are added and the formula to obtain the bans assignment ratio can be obtained as follows. Weight value of PC1=5/7*6 Mbps, while weight value of PC3=1/7*6 Mbps.

Accordingly, the bandwidth to be assigned of the PC1 becomes 4.3 Mbps, while that of the PC3 becomes 1.7 Mbps.

The server selector 210 searches the server manager 110 along the bandwidth assigned and also searches the program of content request and content server which satisfies the bandwidth condition. As the assignment of the content bandwidth near the bandwidth to be assigned, it is judged that the PC1 can select the high quality server (4 Mbps), while the PC3, the intermediate quality server (2 Mbps).

(B2) Re-Assignment of Bandwidth with Switching of Content Server

The multicast proxy apparatus is required to change the present bandwidth of the PC3 to 2 Mbps from 4 Mbps with re-assignment of bandwidth of the terminal. The bandwidth changing procedures will be explained below.

The multicast proxy apparatus transmits, to the edge router, stoppage of reception (Block (2004:9:2::1, ff3e:100::2:1) for the Gr2 high quality server (2004:9:2::1) received by the PC3.

(B3) Reception Stop Process in Edge Router

Upon reception of the reception stop process (block), the edge router stops transmission of multicast to the multicast proxy apparatus which has issued the reception stop request and also transmits the Prune (Gr2 (2004:9:2::1)) to the FHR if the other multicast user is not received. Upon reception of the Prune, the FHR stops transmission of the multicast packets to the edge router. The bandwidth of 4 Mbps can be used additionally in the multicast proxy apparatus.

(B4) Content Request to Edge Router

Next, the multicast proxy apparatus transmits, to the edge router, the content request (Allow (2004:9:2::2Gr2)) for receiving the intermediate quality content from the Gr2 content server (bandwidth: 2 Mbps) In this case, since “high” is designated as the DSCP priority, the process is carried out to execute the high packet transfer. Moreover, since the content is not the “pay”-content, ordinary process is carried out. But, the content is matched with the designated “pay”-content, genre, and registered program, the server is selected with use of the weight value of the designated magnification factor (integer or integer having fixed point).

(B5) Content Request to FHR from Edge Router

The edge router having received the content request from the multicast proxy apparatus extends the connection for the multicast communication to the First Hop Router for accommodating the Gr2 content server (2004:9:2::2) designated with use of Join of the PIM-SSM protocol on the basis of the received content request (Allow(2004:9:2::2, Gr2)). In this example, the PIM-SSM protocol is used, but the other multicast protocol may also be used.

(B6) First Hop Router (FHR)

Upon reception of Join to the designated Gr2 content server (2004:9:2::2) using the PIM-SSM protocol, the FHR starts transmission of the multicast packets from the Gr2 content server (2004:9:2::2) to the edge router.

With start of this multicast communication, the multicast proxy apparatus is capable of receiving the content from the Gr2 content server (2004:9:2::2). The received multicast packets are transferred, with the filtering processor 220, to the PC3 which has issued the content request. Moreover, when there is a PC which has issued the content request to the Gr2 content server (2004:9:2::2) like the PC3, the received multicast packets are also transferred to such PC with the filtering processor 220.

The filtering processor 220 shields (filters) the multicast packets (transmission source address is 2004:9:2::1) from the content server (4 Mbps) in order to not allowing co-existence of the packets of both content server (4 Mbps) connected first and the content server (2 Mbps) connected after the switching. The PC3 is capable of receiving the content transmitted from the Gr2 content server (2004:9:2::2).

The server selector 210 sets the bandwidth used of 4 Mbps for the PC3 to the terminal state manager 150. Moreover, the server setter 210 may update the bandwidth used of the terminal state manager 150 in accordance with the request to the edge router such as allow and block or the like.

(B7) Reception of Content Request to Gr1 Server from PC1

The multicast proxy apparatus (MCProxy) transmits, while the PC3 is receiving the content of 2 Mbps or conducting the receiving processes, the content request for the program of Gr1 from the PC1 (high priority: weight is 5) to the edge router. In more detail, the server selector 210 obtains the server address 2004:9:1::1 of the 4 Mbps content of the Gr1 program (high quality contents) from the server manager 110. The server selector 210 transmits, moreover, to the edge router (having the multicast router function), the MLDv2 allow (2004:9:1::1, ff3e:100::1:1) as the content request for the content server (2004:9:1::1) via an IP network side (MLDv2) terminator 290. In this case, since “high” is designated as the DSCP priority, the process is carried out to execute the high packet transfer. Moreover, the content is not the “pay”-content, ordinary process is carried out. When the content is matched with the designated “pay”-content, genre, and registered program, the server can also be selected using the weight value of the designated magnification factor (integer or integer having fixed point).

(B8) Process of Multicast Edge Router

The edge router having received the content request from the multicast proxy apparatus extends the connection, for the multicast communication, to the First Hop Router (FHR) accommodating the designated Gr1 content server (2004:9:1::1), for example, using Join of the PIM-SSM protocol. In this case, when the multicast communication with the content server (2004:9:1::1) is already carried out with the other terminals, a new connection is not extended for the multicast communication with the PIM-SSM protocol.

(B9) First Hop Router (FHR)

The FHR receives the data for multicast communication at least from the Gr1 high quality content server. Upon reception of Join to the designated Gr1 content server (2004:9:1::1) using the PIM-SSM protocol, the FHR starts transmission, to the edge router, of the multicast packets from the Gr1 content server (2004:9:1::1).

With start of this multicast communication, the multicast proxy apparatus is capable of receiving the content from the Gr1 content server (2004:9:2::1). The received multicast packets are transferred, with the filtering processor 220, to the PC1 which has issued the content request. Thereby, the PC1 is capable of receiving the content transmitted from the Gr1 content server (2004:9:1::1).

When the PC1 of higher priority is conducting the channel surfing by switching the multicast programs, congestion is generated to likely give adverse effect on the reception of the other PCs (temporary drop of image quality because of the automatic switching of the bandwidths).

Therefore, it is also possible to select the content of low image quality until the constant time has passed from start of the reception of a certain program.

FIG. 12 is a diagram illustrating the process flow when the PC2 and PC3 have received the identical contents of the identical bandwidth from the same server.

(C1) Reception of Content Request to Gr2 High Priority Server from PC2

The multicast proxy apparatus (MCProxy) receives, during distribution of the content received from the server to the PC1 and PC3, the content request (Report (Gr2)) for the program of Gr2 from the PC2 (intermediate priority: weight value is 4).

The multicast proxy apparatus executes once the termination process for the content request (Report (Gr2)). When the other PC (terminal) desires to issue the content request of the identical multicast in the MLDv1, it is not required to issue the new MLD report because the other terminals can receive the multicast packets.

However, since the multicast proxy apparatus executes the filtering process not to allow the content request (MLD report) from the PC3 and the multicast packets to flow into the PC2 with the filtering processor 220, the PC2 cannot detect reception of the multicast packets. Accordingly, the PC2 controls the multicast proxy apparatus to output the MLD report which is the content request of Gr2.

The server selector 210 judges verifies the server as the connection destination of the terminal state manager 150 and reception by the PC3 of the identical program Gr2 from the program of the server manager and a list of the server addresses.

Since the identical contents are in the identical bandwidths, the weight value of Gr2 can be obtained by adding the weight value 4 of the PC2 and the weight value 2 of the PC3. Namely, the bandwidths can be assigned by utilizing the characteristics of the multicast protocol.

From the calculation explained above, the weight value of the PC1 can be set to 5, the weight values of the PC2 and PC3 can respectively be set to 6. However, the total value of the weight values is equal to 11. Assignment of the bandwidth is obtained on the basis of the total weight value and each weight value. The calculation result is indicated below.
PC1=5/11*6=2.7
PC2=6/11*6=3.3
PC3=6/11*6=3.3

Assignment of bandwidth is conducted for the PC2 and PC3 with priority and the server address of Gr2 which is the content of almost 3.3 Mbps is obtained from the server manager 110. As a result, the nearest content of 4 Mbps is selected. As the other selection standard, it is also allowed to select the server which can provide the content of the bandwidth which is lower than 3.3 Mbps and is nearest thereto. From above explanation, the PC2 and PC3 select the Gr2 high quality server of 4 Mbps, while the PC1 selects the Gr1 low quality server of 1 Mbps.

(C2) Bandwidth Assignment by Switching of Content Server

The multicast proxy apparatus is required first to change the bandwidth of PC1 to 1 Mbps from the present 4 Mbps because of the re-assignment of bandwidths of the PC1 and PC3. Bandwidth changing procedures will be explained below.

The multicast proxy apparatus transmits, to the edge router, the reception stop request (Block (2004:9:1::1, ff3e:100::1:1) to the Gr1 high quality server (2004:9:1::1) received by the PC1.

(C3) Reception Stop Process in Edge Router

Upon reception of the reception stop request (block), the edge router stops requested transmission of multicast to the multicast proxy apparatus. If the request is not received with the other multicast users, the edge router transmits the Prune (2004:9:1::l, ff3e:100::1:1) to the FHR.

(C4) Stop of Multicast Transmission to Edge Router

Upon reception of Prune, the FHR stops transmission of the multicast data packets to the edge router. As the bandwidths in the multicast proxy apparatus, 4 Mbps can be additionally used.

(C5) Content Request to Edge Router

Next, the multicast proxy apparatus transmits, to the edge router, the content request (Allow (2004:9:1::3, Gr1)) to control the PC1 to receive the low quality Gr1 content server (bandwidth: 1 Mbps). In this case, since the “best effort” is designated as the DSCP priority, the process is carried out to realize the packet transfer in the best effort. Moreover, since the content is not the “pay”-content, the ordinary process is carried out. When the content is matched with the “pay”-content, genre, and registered program, the server may be selected by using the weight of the designated magnification factor (integer or integer having fixed point).

(C6) Content Request to FHR from Edge Router

The edge router having received the content request from the multicast proxy apparatus extends the connection for multicast communication to the First Hop Router accommodating the Gr1 content server (2004:9:1::3) designated using Join of the PIM-SSM protocol for the FHR of the Gr1 content server (bandwidth: 1 Mbps) on the basis of the received content request (Allow (2004:9:1::3, Gr1).

(C7) Content Distribution from Server

The multicast proxy apparatus receives the multicast packets from the Gr2 low quality server and distributes these packets to the PC1 via the filtering processor 220.

(C8) Reception Stop Request

The multicast proxy apparatus transmits, to the edge router, the reception stop request (Block (2004:9:2::2, ff3e:100::2:1) for the Gr2 intermediate quality server (2004:9:2::2) which the PC3 has received.

(C9) Reception Stop Process in Edge Router

Upon reception of the viewing stop request (block), the edge router stops multicast transmission for the multicast proxy apparatus requested and also transmits the Prune (2004:9::2, ff3e:100:2:1) if the requests from the other multicast users are not received.

(C10) Stop of Multicast Transmission to Edge Router

Upon reception of the Prune, the FHR stops transmission of the multicast data packets to the edge router. The bandwidth of 2 Mbps can be used additionally in the multicast proxy apparatus.

(C11) Content Request to Edge Router

Next, the multicast proxy apparatus transmits the content request (Allow (2004:9:2::1, Gr2) to the edge router in order to receive the high quality Gr2 content server (bandwidth: 4 Mbps) from the PC2. In this case, since “high” is designated as the DSCP priority, the process is carried out to execute high packet transfer. Moreover, since the content is not the “pay”-content, ordinary processes are carried out. However, the content is matched with the designated “pay”-content, genre, and registered program, the server may be selected using the weight value of the designated magnification factor (integer or integer having fixed point).

(C12) Content Request to FHR from Edge Router

The edge router having received the content request from the multicast proxy apparatus extends connection for multicast communication to the First Hop Router accommodating the designated Gr2 content server (2004:9:2::2) using Join of the PIM-SSM protocol on the basis of the received content request (Allow(2004:9:2::2 Gr2). In this example, the PIM-SSM protocol is used but the other multicast protocol can also be used.

(C13) First Hop Router (FHR)

Upon reception of Join to the designated Gr2 content server (2004:9:2::1) using the PIM-SSM protocol, the FHR starts transmission of multicast packets to the edge router from the Gr2 content server (2004:9:2::1).

With start of this multicast communication, the multicast proxy apparatus is capable of receiving the content from the Gr2 content server (2004:9:2::1). These received multicast packets are then transferred to the PC2 which has issued the content request with the filtering processor 220. Moreover, if a PC which has issued the content request to the Gr2 content server (2004:9:2::1) like the PC2 exists, the received multicast packets are also transferred to this PC with the filtering processor 220.

The filtering processor 220 shields (filtering) the multicast packets (transmission source address is 2004:9:2::2) from the content server (4 Mbps) so that the packets of both content server (2 Mbps) connected first to the PC3 and content server (4 Mbps) connected thereto after the switching. The PC2 and the PC3 can receive the contents transmitted from the Gr2 content server (2004:9:2::1).

The server selector 210 sets the bandwidth used of 4 Mbps for the PC2 and PC3 to the terminal state manager 150. The present invention also includes inventions constituted as explained below.

What is claimed is:

1. A multicast proxy apparatus for transmitting a received multicast packet to a plurality of terminals which have requested contents, comprising
a server manager for managing communication bandwidths corresponding to at least one address required for receiving a plurality of contents from at least one server,
a terminal manager for managing weight or priority order of each terminal, and
a server selector for receiving a content request from one of said terminals, acquiring, from the server manager, at least one bandwidth and at least one address regarding reception of a content, and selecting a server on the basis of one of the weight or priority order of said one of said terminals and a remaining available bandwidths.

2. The multicast proxy apparatus according to claim 1 for adjusting bandwidths of at least one connected terminal by changing the server being connected based on the weight or priority order of said one of said terminal to another server in accordance with a content request from another terminal.

3. The multicast proxy apparatus according to claim 1 for connecting a connection from said one of said terminals to a server of a bandwidth different from that of said content request in accordance with the priority order or weight being set to said one of said terminals.

4. The multicast proxy apparatus according to claim 1 in which a terminal under the control thereof having requested content same as that of said terminal selects a server in accordance with the preset priority order or weight.

5. A multicast proxy apparatus having a function to collate content requested from a terminal under the control thereof with that in said server manager thereof and to select a predetermined server in accordance with information corresponding to registration when such content are identical to the pre-registered particular content.

6. A multicast proxy apparatus having a function to enable setting of a total bandwidth of content requests from a plurality of terminals and disconnecting the content reception session from a preset terminal when the total bandwidth becomes equal to or larger than the setting value.

7. A multicast proxy apparatus for transmitting the received a multicast packet to at least one terminal having issued a content request, comprising
a server manager for managing communication bandwidths corresponding to reception of each content and at least one address required for receiving contents from at least one server; and
a server selector for receiving a content request from a terminal, acquiring, from said server manager, information of one bandwidth and one address for reception of content, and selecting a server on the basis of a remaining available bandwidth and a weight or priority order of said terminal.

8. A method for transmitting a received multicast packet to a plurality of terminals which have requested contents, comprising
managing communication bandwidths corresponding to at least one address required for receiving a plurality of contents from at least one server;
managing a weight or a priority order of each terminal;
receiving a content request from one of said terminals;
acquiring at least one bandwidth and at least one address regarding reception of a content; and
selecting a server on the basis of one of the weight or priority order of said one of said terminals and a remaining available bandwidths.

9. The method of claim 1 further comprising:
adjusting bandwidths of at least one connected terminal by changing the server being connected based on the weight or priority order of said one of said terminal to another server in accordance with a content request from another terminal.

10. The method of claim 1 further comprising:
connecting a connection from said one of said terminals to a server of a bandwidth different from that of said content request in accordance with the priority order or weight being set to said one of said terminals.

11. The method of claim 1 further comprising:
selecting a server in accordance with the preset priority order or weight at a terminal under the control thereof that has requested content same as that of said terminal.
